(19) United States
(12) Patent Application Publication
(10) Pub. No.: US 2007/0148078 A1
(43) Pub. Date: Jun. 28, 2007

(54) Method and system for growing larger precipitated calcium carbonate crystals

(76) Inventors: David R. Skuse, Cornwall (GB); Nigel V. Jarvis, Cornwall (GB); Bruce Jackson, Sandersville, GA (US); Ricardo M. Perez, Cumming, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/582,976

(22) PCT Filed: Dec. 1, 2004
(86) PCT No.: PCT/US04/39955

§ 371 Date: Feb. 2, 2007

Related U.S. Application Data
(60) Provisional application No. 60/529,614, filed on Dec. 16, 2003.

(51) Int. Cl. C01F 11/18; B01J 19/00; B01J 8/00

(52) U.S. Cl. 423/432; 422/189; 422/231

(57) ABSTRACT

The present invention relates to methods of precipitating calcium carbonate (PCC) in a manner that can control the size and surface area of PCC. For example, the calcium carbonate crystals can be formed through the use of two or more doses of slaked lime slurry in the presence of a substrate. Alternatively, the PCC can be formed by combining one or more slaked lime slurry doses with preformed PCC. The invention also relates to a method of precipitating substantially discrete calcium carbonate and to a system for precipitating calcium carbonate.

### DESCRIPTION OF THE INVENTION

This application claims priority to U.S. Provisional Patent Application No. 60/529,614, filed Dec. 16, 2003.

The present invention relates to methods of precipitating calcium carbonate in a manner that can control the size and surface area of the precipitated calcium carbonate (PCC). In some aspects, the present invention also relates to methods of forming composites comprising PCC and a substrate, such as a substrate chosen from fibers and particles.

For some applications, large PCC crystals having a low surface area are desired. Typically, larger PCC crystals are formed by slowing down the reaction rate of carbonation, and thus the rate of precipitation. However, a slower reaction rate can reduce productivity and as a result, increase the costs of manufacturing PCC. Accordingly, there remains a need for controlling the size of PCC without compromising productivity.

One aspect of the present invention provides a method of precipitating calcium carbonate, comprising:

(a) carbonating a mixture comprising a substrate and a first slaked lime slurry;

(b) combining the product of (a) with a second slaked lime slurry; and

(c) carbonating the product of (b).

Another aspect of the present invention provides a method of precipitating calcium carbonate, comprising:

(a) providing a substrate;

(b) combining the substrate with preformed calcium carbonate and a slaked lime slurry; and

(c) carbonating the product of (b).

Another aspect of the present invention provides a method of precipitating calcium carbonate, comprising:

(a) carbonating a mixture comprising preformed calcium carbonate and a first slaked lime slurry; and

(b) combining the product of (a) with a second slaked lime slurry.

Another aspect of the present invention provides a method of precipitating substantially discrete calcium carbonate, comprising:

(a) carbonating a first slaked lime slurry to form a precipitated calcium carbonate having a median particle size of at least about 6 μm;

(b) combining the precipitated calcium carbonate in (a) with a second slaked lime slurry; and

(c) carbonating the product of (b) to form additional precipitated calcium carbonate, wherein a substantial portion of the additional precipitated calcium carbonate is discrete.

Another aspect of the present invention provides a method of precipitating calcium carbonate, comprising:

(a) carbonating a first slaked lime slurry to form a precipitated calcium carbonate;

(b) combining the precipitated calcium carbonate in (a) with a second slaked lime slurry;

(c) carbonating the product of (b); and

(d) combining the of (c) with a third slaked lime slurry.

Another aspect of the present invention provides a system for precipitating calcium carbonate, comprising:

at least one reactor;

at least one lime entry point for adding a slaked lime slurry to the at least one reactor;

a first gas entry point, for adding a carbon dioxide-containing gas to the slaked lime slurry;

at least one additional gas entry point downstream of the first gas entry point, for an additional carbonation; and

at least one vent point to release spent or unused carbon dioxide-containing gas.

Another aspect of the present invention provides a system for precipitating calcium carbonate, comprising:

a first reactor;

at least one lime entry point for adding a slaked lime slurry to the first reactor;

at least one gas entry point, for adding a carbon dioxide-containing gas to the slaked lime slurry to form a precipitated calcium carbonate;

at least one additional reactor connected to and downstream of the first reactor, for receiving the precipitated calcium carbonate formed in the first reactor; and

at least one vent point to release spent or unused carbon dioxide-containing gas.

### BRIEF DESCRIPTION OF THE DRAWING

FIG. 1 is a schematic, cross-sectional diagram of a system comprising a series of reactors for the precipitation of calcium carbonate.

The present invention generally relates to a method of controlling the crystal size of precipitated calcium carbonate. In one aspect, the invention relates to a method of preparing precipitated calcium carbonate having a larger crystal size and lower surface area. In one aspect, the calcium carbonate can be precipitated in the presence of a substrate, such as a substrate chosen from fibers and particles. “Chosen from fibers and particles” refers to a substrate comprising fibers, a substrate comprising particles, or a substrate comprising mixtures thereof.

One aspect of the present invention provides a method of precipitating calcium carbonate, comprising:

(a) carbonating a mixture comprising a substrate and a first slaked lime slurry;

(b) combining the product of (a) with a second slaked lime slurry; and

(c) carbonating the product of (b).

In one aspect, the invention relates to a method of controlling crystal size of a precipitated calcium carbonate by using at least two doses of slaked lime slurry. In another aspect, the method comprises forming precipitated calcium carbonate of a larger size. For example, the first dose can be used to form a precipitated calcium carbonate, such as by performing step (a). The at least one additional lime slurry dose can be combined with the first product, e.g., the product of (a), followed by a second carbonating step, e.g., step (c). In one aspect, the carbonating in (c) can result in the formation of additional precipitated calcium carbonate. In one aspect, “additional precipitated calcium carbonate” comprises larger PCC crystals (e.g., precipitation on previously formed PCC), and/or new PCC crystals.

In another aspect, the method comprises (d) combining the product of (c) with a third slaked lime slurry. In another aspect, the process comprises (e) carbonating the product of (d). In yet another aspect, the process comprises (f) combining the product of (e) with a fourth slaked lime slurry. It can be appreciated that the method can involve as many lime additions as desired in order to obtain a product with the desired particle size or to increase the rate at which crystals having a desired size can be grown.

In one aspect, the use of at least one additional dose of slaked lime slurry allows a crystal of a comparable size to be prepared at an increased carbonation rate.

In one aspect, the slaked lime slurry, such as in (a) and (b), can be a suspension of calcium hydroxide in an aqueous medium. Alternatively, the slaked lime slurry can be prepared, for example, by slaking an alkaline earth metal oxide, such as calcium oxide, or by adding calcium hydroxide to an aqueous medium. In another aspect, the slaked lime slurry can be prepared from a mixture of calcium oxide and calcium hydroxide in an aqueous medium.

In one aspect, the calcium hydroxide is present in the suspension during the slaking process in an amount ranging from about 0.5 mol to about 3.0 mol per liter, such as an amount ranging from about 0.5 mol to about 2.0 mol per liter. In another aspect, the calcium hydroxide is present in a concentration ranging from about 2% to about 30% by weight relative to the total weight of the slurry.

The temperature of the aqueous medium containing the slaked lime slurry, may range from about 0° C. to about 100° C. The temperature can rise during the slaking process. If the aqueous medium is not at the appropriate temperature after slaking, it may be heated or cooled to achieve the desired temperature before further use.

In one aspect, the carbonating, such as in steps (a) and/or (c), can comprise combining the mixture or products of, e.g., (a) and (b), with a carbon dioxide-containing gas. The carbon dioxide-containing gas may be substantially pure carbon dioxide, such as the gas supplied in a compressed gas cylinder, or may be present in a mixture with other gases. The supplied carbon dioxide gas may be diluted with other gases, such as air, nitrogen, etc. The dilute carbon dioxide may be present as a mixture of spent gases such as flue gases, e.g., obtained from a paper mill process (e.g. from boilers, etc.). The gas may be applied under pressure.

In one aspect, the rate of precipitation can be controlled by controlling the rate of addition of the carbon dioxide-containing gas. In one aspect, the carbonating in, e.g., (a) and/or (c), can comprise adding the carbon dioxide-containing gas such that precipitation of calcium carbonate occurs at a rate greater than 0.5 g·L⁻¹min⁻¹ or greater than 0.75 g·L⁻¹min⁻¹, such as a rate ranging from about 0.5 g·L⁻¹min⁻¹ to about 1.5 g·L⁻¹min⁻¹, a rate ranging from about 0.75 g·L⁻¹min⁻¹ to about 1.5 g·L⁻¹min⁻¹, or a rate ranging from about 0.5 g·L⁻¹min⁻¹ to about 1.25 g·L⁻¹min⁻¹. In another aspect, the precipitation of calcium carbonate occurs at a rate of about 0.75 g·L⁻¹min⁻¹, or about 1 g·L⁻¹min⁻¹.

In one aspect, the product of (a) comprises precipitated calcium carbonate having a median particle size of at least about 0.5 μm, such as, for example, a median particle size of at least about 0.6 μm. In view of the present disclosure, one of ordinary skill in the art will appreciate that the use of at least one additional slaked lime slurry dose, such as the calcium carbonate formed in (c), can result in a precipitated calcium carbonate having a larger crystal size, such as, for example, a median particle size greater than about 0.7 μm, such as for example greater than about 1 μm or greater than about 2 μm. In another aspect, the precipitated calcium carbonate formed after at least one additional slaked lime slurry dose, such as in step (c), has a median particle size of at least about 2.4 μm, such as a median particle size of at least about 2.5 μm, or at least about 5 μm, or at least about 10 μm.

One of ordinary skill in the art would appreciate that, generally, as the crystal size increases, the total surface area decreases. In one aspect, the use of at least one additional slaked lime slurry dose, such as the calcium carbonate formed in (d), can result in a precipitated calcium carbonate having a BET surface area of about 6.0 m²g⁻¹ or less, such as a BET surface area of about 5.5 m²g⁻¹ or less, or a BET surface area of about 5.0 m²g⁻¹ or less. In another aspect, the use of at least one additional slaked lime slurry dose, such as the calcium carbonate formed in (c), can result in a precipitated calcium carbonate having a Blaine surface area of about 21,000 cm²g⁻¹ or less, such as a Blaine surface area of about 20,000 cm²g⁻¹ or less, a Blaine surface area of about 19,000 cm²g⁻¹ or less, or Blaine surface area of about 18,000 cm²g⁻¹ or less.

The carbonating process may be continued until the pH of the aqueous medium has fallen to a pH of about 9.0 or less, such as a pH of about 7.0 or less. The pH can be monitored until it falls and then becomes stable. This pH behavior can indicate that substantially all of the alkaline earth metal ions have been consumed, such as by consumption of the calcium hydroxide present in the aqueous medium.

It is known, for example, that the reaction conditions employed to produce a precipitated calcium carbonate product can be selected to aim for a predominant precipitate crystal form, e.g., scalenohedral, aragonite or rhombohedral, which have enhanced properties when used in paper. Such reaction conditions may be selected as understood by one of ordinary skill in the art. In one aspect, the precipitated calcium carbonate has a scalenohedral crystal form as the predominant crystal form.

The reactor vessel in which the precipitation reaction is carried out to produce the composition may take various forms depending on the process conditions required to be operated as described herein. Reactor vessels useful for the production of precipitated calcium carbonate from slaked lime and carbon dioxide gas may be employed. The reaction may be carried out as a batch, continuous or semi-continuous process as appropriate in a wide variety of reactors.

In one aspect, the substrate, such as in (a), can be chosen from particulate and fibrous materials. In one aspect, the substrate source is a suspension comprising organic and/or inorganic particles and/or fibers. These particles and/or fibers can be new particles or fibers, or generated as a waste stream. Exemplary substrate sources include a new fiber stream, or a waste stream, such as whitewater from a paper machine or an effluent stream from a paper mill.

In one aspect, the substrate comprises fibers. The fibers can originate from any source, as known to one of ordinary skill in the art. For example, the substrate can comprise new or ‘unused’ fibers such as long fibers (i.e. ‘virgin fibers’) produced by refining pulp. In one aspect, the fibers have a size such that the resulting composition according to the present invention is sufficient for use in paper making applications.

In another aspect, the substrate may comprise a whitewater stream containing material which has passed through the sheet forming wire(s) of a paper making machine. Whitewater can typically include a mixture of fibres, fines particles of mineral filler and chemicals that were not retained during the paper sheet forming process. These fibers and particles generally have a size such that they can pass through the openings in the sheet forming wire(s) of the paper making machine.

In another aspect, the substrate may comprise a fiber-containing stream derived from a recycled material such as processed re-pulped waste paper or ‘broke’. During the paper making process, a significant amount of the formed sheet has defects, imperfections or is otherwise unsuitable for use. This material, referred to as ‘broke’, is often re-pulped and reused in the preparation of papermaking stock to increase the efficiency of the paper making plant. In another embodiment, the fiber-containing stream may be derived from re-pulped paper recycled by consumers.

In another aspect, the substrate may comprise a particulate mineral, such as for example a white particulate mineral of the sort commonly used as a white pigment or filler in papermaking. For example, the substrate can include particles of kaolin, natural (ground) calcium carbonate, precipitated calcium carbonate, talc, TiO₂, etc. In one aspect, the substrate includes preformed crystals of precipitated calcium carbonate. In another aspect, the substrate includes kaolin stacks and/or plates.

In one aspect, the substrate includes a mixture of particles and fibers. In another aspect, the particles comprise an inorganic material, such as any of the minerals described herein. In one aspect, the inorganic material comprises at least about 2%, or at least about 5% by weight of the total substrate. In another aspect, the inorganic material is present in an amount ranging from about 2% to about 85% by weight of the total substrate. Additionally, the substrate may include cellulosic fibers, ink particles, latex particles and resin particles, e.g. urea-formaldehyde, and mixtures thereof, any of which may be bound to inorganic particles.

In one aspect, the slaked lime slurries are degritted prior to combining with the substrate. Degritting can be performed with any degritting procedure suitable for removing grit, such as screening, fine screening or classifying, or centrifuging. The degritting can be performed with a cyclone, for example a hydrocyclone, as described in a copending provisional application entitled “Preparation of a Composition Comprising an Alkaline Earth Metal Oxide and a Substrate having a Reduced Amount of Grit,” filed Oct. 1, 2003. For example, the degritting can comprise screening the slaked lime slurry, followed by hydrocycloning the screened slurry. The screening can be performed with a 60 mesh screen, or a 100 mesh screen. In another aspect, the degritting can be performed using a centrifuge, such as a solid bowl decanter centrifuge, a disc nozzle centrifuge, or the like.

The substrate may be pre-treated to render it suitable for precipitation. For example, if the substrate is present as a suspension, the suspension may be concentrated or diluted as described hereinafter or the suspension may be subjected to a processing step, for example, treatment by a surface treatment agent in a known way to give the particles and/or fibers in the suspension a surface chemical and/or physical functionality.

Another aspect of the present invention provides a method of precipitating calcium carbonate, comprising:

(a) providing a substrate;

(b) combining the substrate with preformed calcium carbonate and a slaked lime slurry; and

(c) carbonating the product of (b).

In one aspect, the preformed calcium carbonate includes any type of calcium carbonate, such as ground calcium carbonate or precipitated calcium carbonate. The preformed calcium carbonate can be prepared by any method known to one of ordinary skill in the art, or purchased from commercially available sources. The preformed calcium carbonate can be of any size necessary for the ensuing application.

In one aspect, the product of (b) can result from combining preformed crystals (e.g., prepared in a separate reaction or obtained from a commercially available source) with the substrate and a slaked lime slurry. In another aspect, the preformed calcium carbonate can be prepared in situ, e.g., by combining the substrate with a first dose of slaked lime slurry, followed by a carbonating step to precipitate the calcium carbonate. The product of (b) can then be formed by combining this precipitated calcium carbonate (i.e., the preformed calcium carbonate) with the substrate and a second dose of slaked lime slurry. Alternatively, the preformed calcium carbonate can be prepared in situ in the presence of the substrate, and the product of (b) can be formed by combining this product (substrate and resulting preformed calcium carbonate) with a second dose of slaked lime slurry.

It can be appreciated that the product from the carbonating in (c) can be combined with at least one additional dose of a slaked lime slurry.

In another aspect, the product of (c) can comprise calcium carbonate precipitated on the preformed calcium carbonate, e.g., larger calcium carbonate crystals. In another aspect, the product of (c) can also comprise new precipitated calcium carbonate crystals.

Another aspect of the invention provides a method of precipitating calcium carbonate, comprising:

(a) carbonating a mixture comprising preformed calcium carbonate and a first slaked lime slurry; and (b) combining the product of (a) with a second slaked lime slurry.

In one aspect, the method further comprises carbonating the product of (b). Accordingly, the precipitated calcium carbonate formed in this aspect can be the product of combining the preformed calcium carbonate, as described herein, with two or more doses of slaked lime slurry, each dose followed by carbonation.

Another aspect of the present invention provides a method of precipitating substantially discrete calcium carbonate, comprising:

(a) carbonating a first slaked lime slurry to form a precipitated calcium carbonate having a median particle size of at least about 0.6 μm; (b) combining the precipitated calcium carbonate in (a) with a second slaked lime slurry; (c) carbonating the product of (b) to form additional precipitated calcium carbonate, wherein a substantial portion of the additional precipitated calcium carbonate is discrete.

In one aspect, the substantially discrete calcium carbonate comprises crystals and/or particles that are substantially non-aggregated, .e.g., exist as individual crystals. In one aspect, at least about 90% by weight of the calcium carbonate is discrete, such as an amount of at least about 95% by weight.

Another aspect of the present invention provides a system for precipitating calcium carbonate. In one aspect, the system allows multiple stages of slaked lime additions. In another aspect, multiple carbonations can be performed.

In another aspect, the system comprises: at least one reactor; at least one lime entry point for adding a slaked lime slurry to the at least one reactor; a first gas entry point, for adding a carbon dioxide-containing gas to the slaked lime slurry; at least one additional gas entry point downstream of the first gas entry point, for an additional carbonation; and at least one vent point to release spent or unused carbon dioxide-containing gas.

In one aspect, the system comprises: a first reactor; at least one lime entry point for adding a slaked lime slurry to the first reactor; at least one gas entry point, for adding a carbon dioxide-containing gas to the slaked lime slurry to form a precipitated calcium carbonate; at least one additional reactor connected to and downstream of the first reactor, for receiving the precipitated calcium carbonate formed in the first reactor; and at least one vent point to release spent or unused carbon dioxide-containing gas.

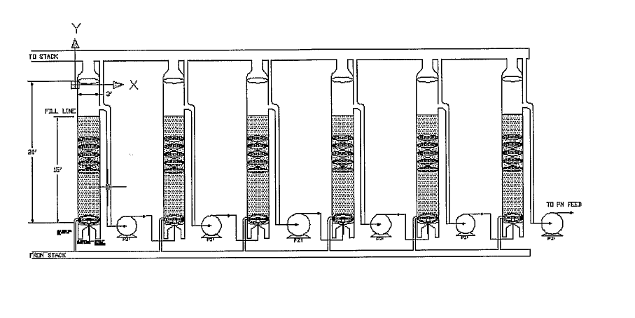

One aspect of the invention is illustrated in FIG. 1, which is a schematic, cross-sectional diagram of system 2, for the precipitation of calcium carbonate. System 2 comprises six reactors 4a-f connected in series. It can be appreciated that six reactors have been drawn for illustrative purposes, and any number of two or more reactors can be used as desired. Reactors 4a-f are drawn as static in-line helical mixers although it can be appreciated that many other reactor types are known in the art that can perform the function of 4a.

In using system 2 of FIG. 1, a slaked lime slurry enters the first reactor, 4a, via a pipe (not shown) located at position 22 at the bottom of reactor 4a. Similar slaked lime slurry entry points can be provided on each of the other reactors 4b-4f. In one aspect, one or more of lime entry points 4b-4f can provide at least one lime entry point downstream of the lime entry point 4a. It can be appreciated, however, that one of ordinary skill in the art can vary the lime entry positions as desired. The slaked lime slurry can also contain a substrate and/or preformed calcium carbonate and/or other mineral, if desired.

Carbonation of the slaked lime can be achieved by introducing a carbon dioxide-containing gas, such as a flue gas, through main gas line 8. Line 8 extends along a path parallel to the series of pipe reactors 4a-f. Individual feed lines 8a-f stem from line 8 and lead to gas entry points 10a-f, which can be, for example, sparger rings. Thus, system 2 provides at least one gas entry point (e.g., one or more of gas entry points 10b-10f) downstream of gas entry point 10a. FIG. 1 illustrates gas entry points 10a-f as positioned at the bottom of the respective reactors 4a-f, although any location that ensures adequate gas mixing can be envisioned. Through gas entry points 10a-f, the carbon dioxide-containing gas can enter each of reactors 4a-4f. The flow rate of the carbon dioxide-containing gas through main gas line 8 and each individual entry point 10a-f can be controlled by devices well known to those of ordinary skill in the art.

In one aspect, “downstream” refers to the slurry pathway as it traverses from reactor 4a and along one or more of reactors 4b-4f.

In operation, the carbon dioxide-containing gas entering point 10a combines with the slurry (entering reactor 4a through position 22) as it continuously enters the reactor 4a. The slurry overflows through point 12a and into outlet pipe 16a, which leads to transfer pump 18a. Transfer pump 18a may be designed to handle slurries, such slaked lime slurries, or mixtures containing fibers and/or particles. The mixture, including newly formed PCC, passes from pump 18a to line 20a and enters reactor 4b, where the process is repeated. Additional slaked lime slurry can be introduced at the bottom of reactor 4b (as in reactor 4a), although one of ordinary skill in the art can vary the slurry/lime entry point position within the reactor as desired. Reactor 4b has its own gas entry point, 8b, which exposes the slaked lime/PCC mixture to a fresh source of carbon dioxide-containing gas. The carbonating process is repeated in reactor 4b, with the product slurry exiting reactor 4b and into reactor 4c. The final product exits reactor 4f (or the last reactor in the series) and can be used for the desired application.

In one aspect, reactors 4a-4f can be, for example, a static in-line helical mixer. A static in-line helical mixer can allow the slaked lime/PCC mixture to be exposed to an adequate amount of the carbon dioxide-containing gas. FIG. 1 shows lines 6a-6f (optional) in the respective reactors 4a-4f. Lines 6a-f can provide a helical pathway, resulting in a longer distance for the slurry to travel, and thereby allowing a longer time for the slurry/gas reaction to occur.

In one aspect, any spent or unused gas can exit each of reactors 4a-4f through respective vent points 12a-f, which leads to individual gas exit lines 14a-14f that eventually meet at main gas exit line 14. FIG. 1 shows main gas exit line 14 running parallel main gas line 8, although one of ordinary skill in the art can appreciate that any arrangement of gas lines will suffice so long as they perform the desired gas entry and exit functions. FIG. 1 illustrates vent points 12a-f to function as both the slurry overflow to outlet pipes 16a-f and the vent point to exit gas lines 14a-f. Alternatively, the outlet/vent points to the slurry outlet pipes and gas exit lines can be positioned at separate locations if desired.

In one aspect, each of subsequent reactors 4b-f can also have individual lime/slurry entry points to allow a user to input a fresh dose of slurry into these subsequent reactors. For example, PCC formed in reactor 4a can enter reactor 4b and be exposed to a second dose of lime slurry.

In one aspect the composition may be used in any application, such as a filler or pigment for paper making, e.g., a paper comprising the filler composition according to the invention, or alternatively as a filler for other known particulate filler or extender and/or reinforcing applications, such as in polymer, paint, resin, cement, and concrete compositions, and the like. For example, the composition can be used as a filler in a polymer. The solids-containing suspension may, if required, be diluted for use at the user plant.

The aqueous suspension containing an aggregate of precipitate and fines formed by the method according to the present invention may be dewatered prior to supply for use in a user application, e.g., re-use in the paper mill. For example, processes such as filtration, sedimentation, centrifugation and/or evaporation may be used. Alternatively, the aqueous suspension or slurry may be delivered to a storage tank or directly to the user plant without substantial dewatering.

The product may be supplied in one of various concentrations in water. The concentration may range from dilute suspension form to dry particulate solids. The product after formation in the method according to the present invention may or may not be treated as appropriate, e.g., by dewatering or not, so that it may be delivered to the user plant, e.g., paper making mill, in the required concentration.

If desired, a reducing or oxidizing bleaching agent may be added to the suspension containing the composition to improve its whiteness. The reducing bleaching agent may be, for example, a dithionite salt such as sodium or zinc dithionite, or zinc dust, sulphur dioxide, and formamidine sulfinic acid (FAS). The amount of the reducing bleaching agent used can range from, for example, about 1.5 to about 7.5 grams of the reducing bleaching agent per kilogram of dry particulate material.

The suspension containing the precipitated alkaline earth metal carbonate and substrate (e.g., an industrial by-product) may be added directly in its relatively dilute form to a paper making composition to provide a filler for the paper making fibers. Alternatively, the suspension may be dewatered by any conventional method, for example by pressure filtration or in a centrifuge.

In any event, as will be clearly evident to those familiar with the paper making art, the product may be blended in various proportions with conventional filler materials, e.g., precipitated or natural (e.g. ground), calcium carbonate, kaolin and other clay minerals, metakaolin, talc, calcium sulphate etc., the ingredients and composition as well as the host fibers being selected according to the quality of paper required to be produced. In general, these materials are often in slurry form when they are mixed.

The invention will be further clarified by the following non-limiting examples, which are intended to be purely exemplary of the invention.

### EXAMPLE 1

This Example demonstrates the preparation of calcium carbonate formed by the addition of a second dose of lime. The resulting precipitated calcium carbonate has increased median particle size and reduced surface area by the addition of a second dose of lime, as shown in Table 1 below. The precipitated calcium carbonate can also advantageously be prepared at an increased carbonation rate in accordance with the method of the present invention.

TABLE 1

| | | | Sur- | | | Car- | |
|---|---|---|---|---|---|---|---|
| | Carbon- | | face | Surface | | bona- | |
| | ation | Mean | area | area | Slake | tion | |
| | Rate | Particle | BET | Blaine | start | start | |
| | (g · L⁻¹ | Diame- | (m² | (cm² | temp | temp | |
| Sample | min⁻¹) | ter (μm) | g⁻¹) | g⁻¹) | (° F.) | (° F.) | Comment |
| Control | 1.0 | 2.36 | 6.0 | 20300 | 100 | 140 | Control |
| A | | | | | | | |
| Control | 1.0 | 2.29 | 5.9 | 20700 | 100 | 140 | Control |
| B | | | | | | | |
| Control | 0.75 | 2.42 | 5.2 | 19000 | 100 | 150.9 | Control |
| C | | | | | | | |
| Control | 0.75 | 2.41 | 4.9 | 19100 | 100 | 158.0 | Control |
| D | | | | | | | |
| Sample | 1.0 | 2.85 | 4.0 | 15700 | 145 | 153.7 | 70% Control |
| A | | | | | | | A + 30% |
| | | | | | | | lime |
| Sample | 1.0 | 2.49 | 4.9 | 17500 | 145 | 153.7 | 85% Control |
| B | | | | | | | B + 15% |
| | | | | | | | lime |
| Sample | 1.0 | 2.51 | 5.4 | 18200 | 100 | 140 | Carb stopped |
| C | | | | | | | at 20 g/L, |
| | | | | | | | 20% lime |
| | | | | | | | added. carb |
| | | | | | | | completed |
| Sample | 1.0 | 2.56 | 5.7 | 18600 | 100 | 140 | Carb stopped |
| D | | | | | | | at 20 g/L, |
| | | | | | | | 20% lime |
| | | | | | | | added. carb |
| | | | | | | | completed |
| Sample | 1.0 | 2.39 | 5.7 | 19800 | 100 | 158.8 | Carb stopped |
| E | | | | | | | at 20 g/L, |
| | | | | | | | 25% lime |
| | | | | | | | added, carb |
| | | | | | | | completed |
| Sample | 1.0 | 2.71 | 4.5 | 16600 | 100 | 140 | Carb stopped |
| F | | | | | | | at 4 g/L, |
| | | | | | | | 25% lime |
| | | | | | | | added, carb |
| | | | | | | | completed |

The slaked lime slurry was prepared in a hydration process at a consistency of circa 15% solids as calcium hydroxide.

Controls A through D comprise PCC prepared with the addition of a single dose of lime. Controls A and B were prepared by carbonating the circa 15% solids slaked lime slurry to precipitate calcium carbonate at a reaction rate of 1 g·L⁻¹min⁻¹. Calcium carbonate Controls C and D were precipitated at a lower reaction rate of 0.75 g·L⁻¹min⁻¹.

Sample A was prepared by mixing a portion of Control A and a second dose of lime followed by further carbonating. Sample B was prepared by mixing a portion of Control B and a second dose of lime followed by further carbonating. Both Samples A and B were prepared at a reaction rate of 1.0 g·L⁻¹min⁻¹. The final product in Sample A contained 70% by weight PCC from Control A and 30% by weight PCC formed from the second dose of lime. The final product in Sample B contained 85% by weight PCC from Control B and 15% by weight PCC formed from the second dose of lime. Sample A had a median particle size of 2.85 μm and a corresponding surface area of 4.0 m²g⁻¹. Sample B had a median particle size of 2.5 μm and a corresponding surface are of 4.9 m²g⁻¹. Both Samples A and B display a greater particle size and lower surface area than any of Controls A-D The data suggest that, coarser and lower surface area material can be produced at higher reaction rates using the method of the invention.

Samples C and D were prepared by first adding 80% by weight of the total lime slurry followed by carbonation at a reaction rate of 1.0 g·L⁻¹min⁻¹. The carbonation was stopped when the lime concentration reached 20 g/L and the final 20% of the total lime was added. Carbonation resumed at a reaction rate of 1.0 g·L⁻¹min⁻¹. These samples had a median particle size of about 2.5 μm and a corresponding surface area of about 5.5 m²g⁻¹

Sample E was prepared by first adding 75% by weight of the total lime slurry followed by carbonation at a reaction rate of 1.0 g·L⁻¹min⁻¹. After stopping the carbonation when the lime concentration reached 20 g/L, the final 25% of the total lime was added. Carbonation resumed at a reaction rate of 1.0 g·L⁻¹min⁻¹. The sample had a median particle size of 2.4 μm and a corresponding surface area of 5.7 m²g⁻¹.

Sample F was prepared by first adding 75% by weight of the total lime slurry followed by carbonation at a reaction rate of 1.0 g·L⁻¹min⁻¹. After stopping the carbonation when the lime concentration reached 4 g/L, the final 25% of the total lime was added. Carbonation resumed at a reaction rate of 1.0 g·L⁻¹min⁻¹. The sample had a median particle size of 2.7 μm and a corresponding surface area of 4.4 m²g⁻¹.

Samples C to F, further demonstrate the utility of the invention for preparing coarser and lower surface area PCC's. The samples, C to F, also illustrate the utility of the invention for the preparation of coarser and lower surface area PCC's at increased reaction rate.

### EXAMPLE 2

This Example demonstrates that a composite comprising PCC and fibers can be prepared with larger PCC crystals by including preformed PCC crystals in the reactor.

The preformed PCC used in this example was scalenohedral having the following characteristics: BET surface area 5.2 m²g⁻¹ and Blaine surface area 19300 cm²g⁻¹.

The substrate comprised KRAFT pulp that was repulped to a freeness of 100 CSF (Canadian Standard Freeness) at a consistency of 2% solids. The reactions described in this example involved 10 L of the substrate at 2% solids. The slaked lime slurry used had a concentration of 15% solids.

The products were prepared having approximately 1 to 1 substrate to PCC weight ratio.

Control E was prepared by combining the substrate with 1.0 L of slaked lime slurry. The mixture was carbonated to precipitate calcium carbonate at a reaction rate of 1 g·L⁻¹min⁻¹.

Sample G was prepared by combining the preformed crystals with the substrate and 0.875 L of the slaked lime slurry. The mixture was carbonated to precipitate calcium carbonate at a reaction rate of 1 g·L⁻¹min⁻¹. The preformed crystals made up 12.5 wt. % of the total calcium carbonate in the final PCC product.

Sample H was prepared by combining the preformed crystals (50 wt. % of the total calcium carbonate in the final PCC product) with the substrate and 0.5 L of the slaked lime slurry. The mixture was carbonated to precipitate calcium carbonate at a reaction rate of 1 g·L⁻¹min⁻¹.

As shown in Table 2 below, Samples G and H displayed a lower surface area than Control E, indicating growth of the size of the preformed PCC.

TABLE 2

| | | Surface | |
|---|---|---|---|
| | | area | |
| | Surface area | Blaine | |
| Sample ID | BET (m²g⁻¹) | (cm²g⁻¹) | Comments |
| Control E | 6.5 | 34000 | Control |
| Sample G | 5.9 | 27700 | 12.5 wt. % PCC added preformed |
| Sample H | 3.0 | 15300 | 50 wt. % PCC added preformed |

These data show that adding some of the PCC to the reaction in a preformed state allows the preparation of lower surface area crystals in the presence of the substrate. This composite is expected to give better performance in terms of size demand, strength, optical performance and drainage when incorporated into a paper sheet.

No noticeable settling of fiber or pigment-fiber complex was observed. The pH of the samples remained steady. Upon subjecting the composites to a 450 Watt sonicator for 5 minutes, no breakening or loosening of the composites was observed.

### EXAMPLE 3

This example demonstrates the effect of increasing the number of lime additions.

The substrate comprised KRAFT pulp that was repulped to a freeness of 100 CSF (Canadian Standard Freeness) at a consistency of 2% solids. The reactions described in this example involved 10 L of the substrate at 2% solids. The slaked lime slurry used had a concentration of 15% solids.

The products were prepared having approximately 1 to 1 substrate to PCC weight ratio.

Control F was prepared by combining the substrate with 1.0 L of slaked lime. The mixture was carbonated to completion at a reaction rate of 1 g·L⁻¹min⁻¹.

Sample I was prepared by combining the substrate with 0.5 L of slaked lime. The mixture was carbonated to completion at a reaction rate of 1 g·L⁻¹min⁻¹. At completion a second amount of 0.5 L slaked lime was added and again the mixture was carbonated to precipitate calcium carbonate at a reaction rate of 1 g·L⁻¹min⁻¹.

Sample J was prepared in a similar way to Sample I except that the slaked lime was added in 4 equal additions of 0.25 L followed by carbonation to completion after each lime addition.

These data show the utility of the invention that increasing the number of lime additions gives coarser and lower surface area PCC's.

These data also suggest that this aspect of the invention can be used to prepare PCC of low surface area at faster reaction rates.

TABLE 3

| | Number of slaked | Surface area BET |
|---|---|---|
| Sample ID | lime additions | (m²g⁻¹) |
| Control F | 1 | 5.69 |
| Sample I | 2 | 4.91 |
| Sample J | 4 | 4.64 |

### EXAMPLE 4

This example demonstrates the preparation of a composite comprising PCC and fibers where finer preformed PCC was included in the reactor. This example also demonstrates the preparation of composites including other minerals, such as kaolin.

The fine preformed PCC used in these examples was scalenohedral having the following characteristics: BET surface area 11.0 m²g⁻¹ and Blaine surface area 40,000 cm²g-¹. The substrate used is KRAFT pulp that was repulped to a freeness of 100 CSF (Canadian Standard Freeness) at a consistency of 2% solids. The slaked lime slurry used had a concentration of 15% solids. The reactions described in this example involved 10 L of the substrate at 2% solids.

The products were prepared having approximately 1 to 1 substrate to PCC weight ratio.

Sample K was prepared by combining the fine preformed crystals (12.5 wt. % of total calcium carbonate in the final PCC product) with 10 L of the substrate, 0.875 L of the slaked lime slurry, and 0.25% by weight citric acid. The mixture was carbonated to precipitate calcium carbonate at a reaction rate of 1 g·L⁻¹min⁻¹.

Sample L was prepared by combining the fine preformed crystals (12.5 wt. % of total calcium carbonate in the final PCC product) with 10 L of the substrate, 0.875 L of the slaked lime slurry, and 0.25% by weight phosphoric acid. The mixture was carbonated to precipitate calcium carbonate at a reaction rate of 1 g·L⁻¹min⁻¹.

Sample M was prepared by combining the fine preformed crystals (50 wt. % of total calcium carbonate in the final PCC product) with 10 L of the substrate, and 0.5 L of the slaked lime slurry. The mixture was carbonated to precipitate calcium carbonate at a reaction rate of 1 g·L⁻¹min⁻¹.

Sample N was prepared from preformed crystals and the substrate in the form of a premade PCC/fiber (KRAFT pulp) composite (12.5 wt. % of total calcium carbonate in the final PCC product). The slaked lime slurry was combined with 0.125 L of the composite in four separate equal doses such that the total amount of lime used was 0.875 L. The mixture was carbonated to precipitate calcium carbonate at a reaction rate of 1 g·L⁻¹min⁻¹.

Sample O was prepared from preformed crystals and the substrate in the form of a premade PCC/fiber (KRAFT pulp) composite (50 wt. % of total calcium carbonate in the final PCC product). The slaked lime slurry was combined with 0.5 L of the composite in four separate equal doses such that the total amount of lime used was 0.5 L. The mixture was carbonated to precipitate calcium carbonate at a reaction rate of 1 g·L⁻¹min⁻¹.

Sample P was prepared by the carbonation of slaked lime in the presence of preformed kaolin (12.5% of total mineral) and substrate. The mixture was carbonated to precipitate calcium carbonate at a reaction rate of 1 g·L⁻¹min⁻¹.

These examples illustrate the further scope of this invention in terms of (i) the preparation of a wide range of surface area PCC/substrate composites (ii) formation of composites by precipitation of PCC onto existing PCC/substrate composites and (iii) formation of kaolin/PCC/substrate composites.

TABLE 3

| | Pre-formed | Number of | Surface area | Surface area |
|---|---|---|---|---|
| | Mineral | Slaked Lime | BET | Blaine |
| Sample ID | Dose (wt. %) | Additions | (m²g⁻¹) | (cm²g⁻¹) |
| Sample K | 12.5 | 1 | 13.5 | 42600 |
| Sample L | 12.5 | 1 | 11.0 | 40400 |
| Sample M | 50 | 1 | 6.5 | 29500 |
| Sample N | 12.5 | 4 | 7.3 | 31200 |
| Sample O | 50 | 4 | 6.5 | 29500 |
| Sample P | 12.5 | 1 | 9.9 | 37400 |

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of precipitating calcium carbonate, comprising:
(a) carbonating a mixture comprising a substrate and a first slaked lime slurry;
(b) combining the product of (a) with a second slaked lime slurry; and
(c) carbonating the product of (b).

2. The method according to claim 1, wherein the substrate is chosen from particles and fibers.

3. The method according to claim 1, further comprising:
(d) combining the product of (c) with a third slaked lime slurry.

4. The method according to claim 3, further comprising:
(e) carbonating the product of (d).

5. The method according to claim 4, further comprising:
(f) combining the product of (e) with a fourth slaked lime slurry.

6. The method according to claim 1, wherein the product of (a) comprises a precipitated calcium carbonate having a median particle size of at least about 0.5 μm.

7. The method according to claim 6, wherein the precipitated calcium carbonate has a median particle size of at least about 0.6 μm.

8. The method according to claim 7, wherein the precipitated calcium carbonate has a median particle size of at least about 1 μm.

9. The method according to claim 8, wherein the precipitated calcium carbonate has a median particle size of at least about 2 μm.

10. The method according to claim 7, wherein the product of (c) comprises a precipitated calcium carbonate having a median particle size of at least about 0.7 μm.

11. The method according to claim 10, wherein the precipitated calcium carbonate has a median particle size of at least about 1 μm.

12. The method according to claim 11, wherein the precipitated calcium carbonate has a median particle size of at least about 2 μm.

13. The method according to claim 12, wherein the precipitated calcium carbonate has a median particle size of at least about 2.4 μm.

14. The method according to claim 13, wherein the precipitated calcium carbonate has a median particle size of at least about 2.5 μm.

15. The method according to claim 1, wherein the product of (c) comprises a precipitated calcium carbonate having a BET surface area of about 6.0 m²g⁻¹ or less.

16. The method according to claim 1, wherein the carbonating in (a) and (c) comprises combining concentrated carbon dioxide with the mixture in (a) and the product of (b), respectively.

17. The method according to claim 1, wherein the carbonating in (a) and (c) comprises combining dilute carbon dioxide with the mixture in (a) and the product of (b), respectively.

18. The method according to claim 17, wherein the dilute carbon dioxide is flue gas.

19. The method according to claim 1, wherein the first and second slaked lime slurries each comprise calcium hydroxide in a concentration ranging from about 2% to about 30% by weight relative to the total weight of the slurry.

20. The method according to claim 1, wherein at least one of the first and second slaked lime slurries is degritted prior to the subsequent carbonating.

21. The method according to claim 20, wherein the degritting comprises at least one process chosen from screening, classifying, centrifuging, and hydrocycloning.

22. The method according to claim 21, wherein the degritting comprises screening the slaked lime slurry, followed by hydrocycloning the screened slurry.

23. The method according to claim 22, wherein the slaked lime is screened with a 60 mesh screen or finer.

24. The method according to claim 2, wherein the substrate comprises fibers.

25. The method according to claim 2, wherein the substrate comprises particles.

26. The method according to claim 2, wherein the substrate is chosen from a mixture comprising particles and fibers.

27. The method according to claim 25, wherein the substrate comprises a white particulate mineral.

28. The method according to claim 27, wherein the substrate comprises kaolin plates.

29. The method according to claim 27, wherein the substrate comprises kaolin stacks.

30. The method according to claim 27, wherein the substrate comprises precipitated calcium carbonate.

31. The method according to claim 27, wherein the substrate comprises ground calcium carbonate.

32. The method according to claim 27, wherein the substrate comprises talc.

33. The method according to claim 27, wherein the substrate comprises TiO₂.

34. A paper comprising a composition made according to the process of claim 1.

35. A method of precipitating calcium carbonate, comprising:
(a) providing a substrate;
(b) combining the substrate with preformed calcium carbonate and a slaked lime slurry; and
(c) carbonating the product of (b).

36. The method according to claim 35, wherein the substrate comprises particles.

37. The method according to claim 35, wherein the substrate comprises fibers.

38. The method according to claim 35, wherein the substrate is chosen from a mixture comprising particles and fibers.

39. A method of precipitating calcium carbonate, comprising:
(a) carbonating a mixture comprising preformed calcium carbonate and a first slaked lime slurry; and
(b) combining the product of (a) with a second slaked lime slurry.

40. The method according to claim 39, further comprising:
(c) carbonating the product of (b).

41. The method according to claim 40, further comprising:
(d) combining the product of (c) with a third slaked lime slurry.

42. A method of precipitating substantially discrete calcium carbonate, comprising:
(a) carbonating a first slaked lime slurry to form a precipitated calcium carbonate having a median particle size of at least about 0.6 μm;
(b) combining the precipitated calcium carbonate in (a) with a second slaked lime slurry; and
(c) carbonating the product of (b) to form additional precipitated calcium carbonate, wherein a substantial portion of the additional precipitated calcium carbonate is discrete.

43. The method according to claim 42, wherein the additional precipitated calcium carbonate in (c) has a median particle size of at least about 0.7 μm.

44. The method according to claim 42, wherein the additional precipitated calcium carbonate in (c) has a median particle size of at least about 1.0 μm.

45. The method according to claim 42, wherein the additional precipitated calcium carbonate in (c) has a median particle size of at least about 2.0 μm.

46. The method according to claim 40, wherein the additional precipitated calcium carbonate in (c) has a median particle size of at least about 2.4 μm.

47. The method according to claim 42, wherein the additional precipitated calcium carbonate in (c) has a BET surface area of about 6.0 m²g⁻¹ or less.

48. The method according to claim 42, wherein at least about 90% by weight of the calcium carbonate is discrete.

49. The method according to claim 42, wherein at least about 95% by weight of the calcium carbonate is discrete.

50. The method according to claim 42, wherein the first slaked lime slurry in (a) further comprises a substrate chosen from particulate and fibrous materials.

51. The method according to claim 42, further comprising:
(d) combining the product of (c) with a third slaked lime slurry.

52. The method according to claim 51, further comprising:
(e) carbonating the product of (d).

53. The method according to claim 52, wherein the product of (e) comprises precipitated calcium carbonate having a median particle size of at least about 2.4 μm.

54. A paper comprising a composition made according to the process of claim 42.

55. A method of precipitating calcium carbonate, comprising:
(a) carbonating a first slaked lime slurry to form a precipitated calcium carbonate;
(b) combining the precipitated calcium carbonate in (a) with a second slaked lime slurry;
(c) carbonating the product of (b); and
(d) combining the product of (c) with a third slaked lime slurry.

56. The method according to claim 55, further comprising:
(e) carbonating the product of (d).

57. The method according to claim 55, wherein the first, second, and third slaked lime slurries each comprises calcium hydroxide in a concentration ranging from about 2% to about 30% by weight relative to the total weight of the slurry.

58. The method according to claim 56, wherein the product of (e) comprises precipitated calcium carbonate having a median particle size of at least about 0.7 μm.

59. The method according to claim 56, wherein the product of (e) comprises precipitated calcium carbonate having a median particle size of at least about 1.0 μm.

60. The method according to claim 56, wherein the product of (e) comprises precipitated calcium carbonate having a median particle size of at least about 2.0 μm.

61. The method according to claim 56, wherein the product of (e) comprises precipitated calcium carbonate having a median particle size of at least about 2.4 μm.

62. The method according to claim 56, wherein the product of (e) comprises precipitated calcium carbonate having a BET surface area of about 6.0 m²g⁻¹ or less.

63. A system for precipitating calcium carbonate, comprising:
at least one reactor;
at least one lime entry point for adding a slaked lime slurry to the at least one reactor;
a first gas entry point, for adding a carbon dioxide-containing gas to the slaked lime slurry;
at least one additional gas entry point downstream of the first gas entry point, for an additional carbonation; and
at least one vent point to release spent or unused carbon dioxide-containing gas.

64. The system according to claim 63, further comprising at least one additional lime entry point downstream of the at least one additional gas entry point.

65. A system for precipitating calcium carbonate, comprising:
a first reactor;
at least one lime entry point for adding a slaked lime slurry to the first reactor;
at least one gas entry point, for adding a carbon dioxide-containing gas to the slaked lime slurry to form a precipitated calcium carbonate;
at least one additional reactor connected to and downstream of the first reactor, for receiving the precipitated calcium carbonate formed in the first reactor; and
at least one vent point to release spent or unused carbon dioxide-containing gas.
